(19) United States
(12) Patent Application Publication
(10) Pub. No.: US 2017/0249171 A1
(43) Pub. Date: Aug. 31, 2017

(54) Runtime Configuration of Servlet Filtering Using Dynamic Injection

(71) Applicant: Brocade Communications Systems, Inc., San Jose, CA (US)

(72) Inventor: Ryan Goulding, New Market, NH (US)

(21) Appl. No.: 15/440,139

(22) Filed: Feb. 23, 2017

Related U.S. Application Data
(60) Provisional application No. 62/299,891, filed on Feb. 25, 2016.

(51) Int. Cl. G06F 9/445; G06F 9/455; H04L 29/08

(52) U.S. Cl. CPC G06F 9/44521; H04L 67/02; G06F 9/4552; G06F 9/45504

(57) ABSTRACT

Embodiments according to the present invention introduce a high-level abstraction for specifying and operating dynamic filtering at runtime without service interruption. A CustomFilterAdapter implementation of the javax.servlet.Filter interface is added to the target servlet's configuration. A configuration file and/or data structure are used to establish a chain of responsibility pattern and options for existing and for newly added or removed filters. When the chain of responsibility pattern changes, the filters are started and the CustomFilterAdapter reloads the chain of responsibility. When an HTTP request is received, CustomFilterAdapter processes the filters in the chain of responsibility in the chain order.

### CROSS REFERENCE TO RELATED APPLICATIONS

This application claims the benefit under 35 U.S.C. §119(e) of U.S. Provisional Patent Application Ser. No. 62/299,891 entitled “Runtime Configuration of Servlet Filtering Using Dynamic Injection,” filed Feb. 25, 2016, which is hereby incorporated by reference as if reproduced in its entirety.

### REFERENCE TO A COMPUTER PROGRAM LISTING APPENDIX

The application includes a computer program listing appendix submitted as an ASCII text file, entitled “CustomFilterAdapter_java.txt,” dated Feb. 13, 2017 and 28 kB long, which is hereby incorporated by reference as if reproduced in its entirety.

### BACKGROUND

Java® is a general-purpose computer programming language. A Java application is executed by a Java virtual machine (JVM) executing on an operating system of the computer. Because only the JVM is operating system dedicated, using Java code allows the application to execute on any platform that provides a JVM. As a result, the use of Java code has proliferated, with many fundamental applications being written in Java. For example, Apache Tomcat® is a Java servlet container and web server and is itself written in Java. With this popularity, the Java-related environment has become extremely complex, with many different applications, frameworks and so on being available.

A Java servlet is a Java program that extends the capabilities of a server. A servlet is an object that receives a request and generates a response based on that request. A servlet filter is an object that can intercept HTTP (Hypertext Transfer Protocol) requests targeted at a web application. A servlet filter can intercept requests both for servlets, JSPs (Java Server Pages), HTML (hypertext markup language) files or other static content, as illustrated in FIG. 1. A filter dynamically intercepts requests and responses to transform or use the information contained in the requests or responses. Filters typically do not themselves create responses, but instead provide universal functions that can be “attached” to any type of servlet or JSP page.

Filters are important for a number of reasons. First, they provide the ability to encapsulate recurring tasks in reusable units. Organized developers are constantly on the lookout for ways to modularize their code. Modular code is more manageable and documentable, is easier to debug, and if done well, can be reused in another setting.

Second, filters can be used to transform the response from a servlet or a JSP page. A common task for a web application is to format data sent back to the client. Increasingly the clients require formats (for example, WML (wireless markup language)) other than just HTML. To accommodate these clients, there is usually a strong component of transformation or filtering in a fully featured web application. Many servlet and JSP containers have introduced proprietary filter mechanisms, resulting in a gain for the developer that deploys on that container, but reducing the reusability of such code. With the introduction of filters as part of the Java Servlet specification, developers obtained the opportunity to write reusable transformation components that are portable across containers.

Filters can perform many different types of functions. A few are listed here.

Authentication—Blocking requests based on user identity.

Logging and auditing—Tracking users of a web application.

Image conversion—Scaling maps, and so on.

Data compression—Making downloads smaller.

Localization—Targeting the request and response to a particular locale.

XSL/T transformations of XML (extensible markup language) content—Targeting web application responses to more than one type of client.

These are just a few of the applications of filters. There are many more, such as encryption, tokenizing, triggering resource access events, mime-type chaining, and caching.

One framework is OSGi™ (Open Service Gateway Initiative). The OSGi technology is a set of specifications that define a dynamic component system for Java. These specifications enable a development model where applications are (dynamically) composed of many different (reusable) components. The OSGi specifications enable components to hide their implementations from other components while communicating through services, which are objects that are specifically shared between components. This surprisingly simple model has far-reaching effects for almost any aspect of the software development process.

Layering

The OSGi has a layered model that is depicted in FIG. 2.

The following list contains a short definition of the terms:

Bundles—Bundles are the OSGi components made by the developers.

Services—The services layer connects bundles in a dynamic way by offering a publish-find-bind model for plain old Java objects.

Life-Cycle—The API to install, start, stop, update, and uninstall bundles.

Modules—The layer that defines how a bundle can import and export code.

Security—The layer that handles the security aspects.

Execution Environment—Defines what methods and classes are available in a specific platform.

These concepts are more extensively explained in the following sections.

Modules

The fundamental concept that enables such a system is modularity. Modularity, simplistically said, is about assuming less. Modularity is about keeping things local and not sharing. It is hard to be wrong about things you have no knowledge of and make no assumptions about them. Therefore, modularity is at the core of the OSGi specifications and embodied in the bundle concept. In Java terms, a bundle is a plain old JAR (Java archive) file. However, where in standard Java everything in a JAR is completely visible to all other JARs, OSGi hides everything in that JAR unless explicitly exported. A bundle that wants to use another JAR must explicitly import the parts it needs. By default, there is no sharing.

Though the code hiding and explicit sharing provides many benefits (for example, allowing multiple versions of the same library being used in a single VM), the code sharing was only there to support OSGi services model. The services model is about bundles that collaborate.

Services

The reason for the service model is because Java shows how hard it is to write collaborative models with only class sharing. The standard solution in Java is to use factories that use dynamic class loading and statics. For example, if you want a DocumentBuilderFactory, you call the static factory method DocumentBuilderFactory.newInstance( ). Behind that façade, the newInstance methods tries every class loader trick in the book (and some that aren't) to create an instance of an implementation subclass of the DocumentBuilderFactory class. Trying to influence what implementation is used is non-trivial (services model, properties, conventions in class name), and usually global for the VM. Also it is a passive model. The implementation code cannot do anything to advertise its availability, nor can the user list the possible implementations and pick the most suitable implementation. It is also not dynamic. Once an implementation hands out an instance, it cannot withdraw that object. Worst of all, the factory mechanism is a convention used in hundreds of places in the VM where each factory has its own unique API and configuration mechanisms. There is no centralized overview of the implementations to which your code is bound.

The solution to all these issues is the OSGi service registry. A bundle can create an object and register it with the OSGi service registry under one or more interfaces. Other bundles can go to the registry and list all objects that are registered under a specific interfaces or class. For example, a bundle provides an implementation of the DocumentBuilder. When it gets started, it creates an instance of its DocumentBuilderFactoryImpl class and registers it with the registry under the DocumentBuilderFactory class. A bundle that needs a DocumentBuilderFactory can go to the registry and ask for all available services that extend the DocumentBuilderFactory class. Even better, a bundle can wait for a specific service to appear and then get a call back.

A bundle can therefore register a service, it can get a service, and it can listen for a service to appear or disappear. Any number of bundles can register the same service type, and any number of bundles can get the same service. This is depicted in FIG. 3.

What happens when multiple bundles register objects under the same interface or class? How can these be distinguished? The answer is properties. Each service registration has a set of standard and custom properties. A expressive filter language is available to select only the services in which you are interested. Properties can be used to find the proper service or can play other roles at the application level.

Services are dynamic. This means that a bundle can decide to withdraw its service from the registry while other bundles are still using this service. Bundles using such a service must then ensure that they no longer use the service object and drop any references. This sounds like a significant complexity but it turns out that helper classes like the Service Tracker and frameworks like iPOJO, Spring, and Declarative Services can make the pain minimal while the advantages are quite large. The service dynamics were added to allow installing and uninstalling bundles on the fly while the other bundles could adapt. That is, a bundle could still provide functionality even if the HTTP service went away. However, over time it was determined that the real world is dynamic and many problems are a lot easier to model with dynamic services than static factories. For example, a Device service could represent a device on the local network. If the device goes away, the service representing it is unregistered. This way, the availability of the service models the availability of a real world entity. This works out very well in, for example, the distributed OSGi model where a service can be withdrawn if the connection to the remote machine is gone. It also turns out that the dynamics solve the initialization problem. OSGi applications do not require a specific start ordering in their bundles.

The effect of the service registry has been that many specialized APIs can be much modeled with the service registry. Not only does this simplify the overall application, it also means that standard tools can be used to debug and see how the system is wired up.

Though the service registry accepts any object as a service, the best way to achieve reuse is to register these objects under (standard) interfaces to decouple the implementer from the client code. This is the reason the OSGi Alliance publishes the Compendium specifications. These specification define a large number of standard services, from a Log Service to a Measurement and State specification. All these standardized services are described in great detail.

Deployment

Bundles are deployed on an OSGi framework, the bundle runtime environment. This is not a container like Java Application Servers. It is a collaborative environment. Bundles run in the same VM and can actually share code. The framework uses the explicit imports and exports to wire up the bundles so they do not have to concern themselves with class loading. Another contrast with the application servers is that the management of the framework is standardized. A simple API allows bundles to install, start, stop, and update other bundles, as well as enumerating the bundles and their service usage. This API has been used by many management agents to control OSGi frameworks.

DynamicImport-Package

DynamicImport-Package is not widely used. Its purpose is to allow a bundle to be wired up to packages that may not be known about in advance. When a class is requested, if it cannot be solved via the bundle's existing imports, the Dynamic-ImportPackage allows other bundles to be considered for a wiring import to be added.

CoR introduction

The Chain of Responsibility (CoR) pattern uses a chain of objects to handle a request, which is typically an event. Objects in the chain forward the request along the chain until one of the objects handles the event. Processing stops after an event is handled.

FIG. 4 illustrates how the CoR pattern processes requests.

The Chain of Responsibility pattern has been described like this:

Avoid coupling the sender of a request to its receiver by giving more than one object a chance to handle the request. Chain the receiving objects and pass the request along the chain until an object handles it.

The Chain of Responsibility pattern is applicable if:

You want to decouple a request's sender and receiver

Multiple objects, determined at runtime, are candidates to handle a request

You don't want to specify handlers explicitly in your code

If you use the CoR pattern, remember:

Only one object in the chain handles a request

Some requests might not get handled

Apache Karaf™ is a modern and polymorphic container powered by OSGi. You can deploy different kind of applications in Karaf, OSGi or non-OSGi. Apache Karaf uses either the Apache Felix™ or Eclipse Equinox™ OSGi frameworks, providing additional features on top of the framework. A basic diagram is provided in FIG. 5.

Here is a short list of provided features:

Hot deployment: simply drop a file in the deploy directory, Apache Karaf will detect the type of the file and try to deploy it.

Complete Console: Apache Karaf provides a complete Unix-like console where you can completely manage the container.

Dynamic Configuration: Apache Karaf provides a set of commands focused on managing its own configuration.

All configuration files are centralized in the etc folder. Any change in a configuration file is noticed and reloaded.

Advanced Logging System: Apache Karaf supports all the popular logging frameworks (slf4j, log4j, etc). Whichever logging framework you use, Apache Karaf centralizes the configuration in one file.

Provisioning: Apache Karaf supports a large set of URLs where you can install your applications (Maven™ repository, HTTP, file, etc.). It also provides the concept of “Karaf Features” which is a way to describe your application.

Management: Apache Karaf is an enterprise-ready container, providing many management indicators and operations via JMX.

Remote: Apache Karaf embeds an SSHd server allowing you to use the console remotely. The management layer is also accessible remotely.

Security: Apache Karaf provides a complete security framework (based on JAAS (Java Authentication and Authorization Service)), and provides a RBAC (Role-Based Access Control) mechanism for console and JMX (Java Management Extensions) access.

With the advent of NFV (network function virtualization) and SDN (software defined networks), web services are more widely deployed for operator interaction with systems. Web services are generally defined statically at compile time, thus lacking runtime reconfiguration of filtering, which is necessary for many common use cases. Filtering techniques are not adaptive enough to allow inclusion of filters from multiple vendors (different bundles), or different types of filters (i.e., external firewall, passive identity provider (IdP), etc.). In OSGi in particular, there is no existing mechanism to dynamically specify a variety of Filters located across several bundles. There is need for a generic higher level abstraction to specify filtering behavior at runtime, so it may be reconfigured by operators and systems on the fly to support various use cases without service interruption.

### SUMMARY

Embodiments according to the present invention introduce a high-level abstraction for specifying and operating dynamic filtering at runtime without service interruption. A CustomFilterAdapter implementation of the javax.servlet.Filter interface is added to the target servlet's configuration. A configuration file and/or data structure are used to establish a chain of responsibility pattern and options for existing and newly added or removed filters. When the chain of responsibility pattern changes, the filters are started and the CustomFilterAdapter reloads the chain of responsibility. When an HTTP request is received, CustomFilterAdapter processes the filters in the chain of responsibility in the chain order.

### BRIEF DESCRIPTION OF THE FIGURES

The present disclosure has other advantages and features which will be more readily apparent from the following detailed description of the disclosure and the appended claims, when taken in conjunction with the accompanying drawings, in which:

FIG. 1 is a block diagram of servlet filter interactions.

FIG. 2 is a block diagram of the OSGi structure.

FIG. 3 is a block diagram of servlet operation with bundles.

FIG. 4 is a block diagram of chain of responsibility in OSGi.

FIG. 5 is an Apache Karaf block diagram.

FIG. 6A is a block diagram of an exemplary web server according to the present invention.

FIG. 6B is a block diagram of an exemplary application server according to the present invention.

FIG. 7 is a flowchart of operations to dynamically add a filter for use by CustomFilterAdapter according to the present invention.

FIG. 8 is operation using CustomFilterAdapter according to the present invention.

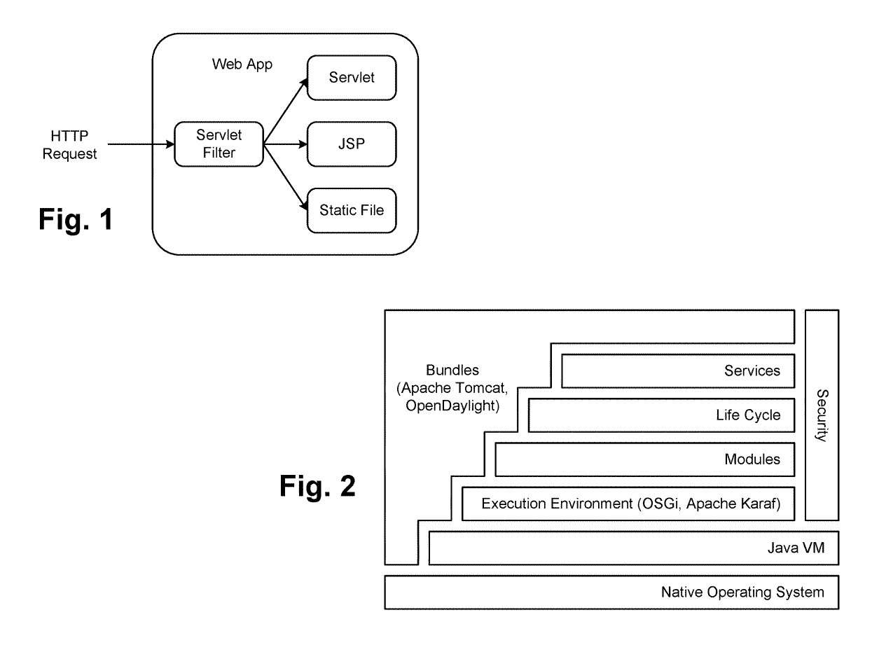

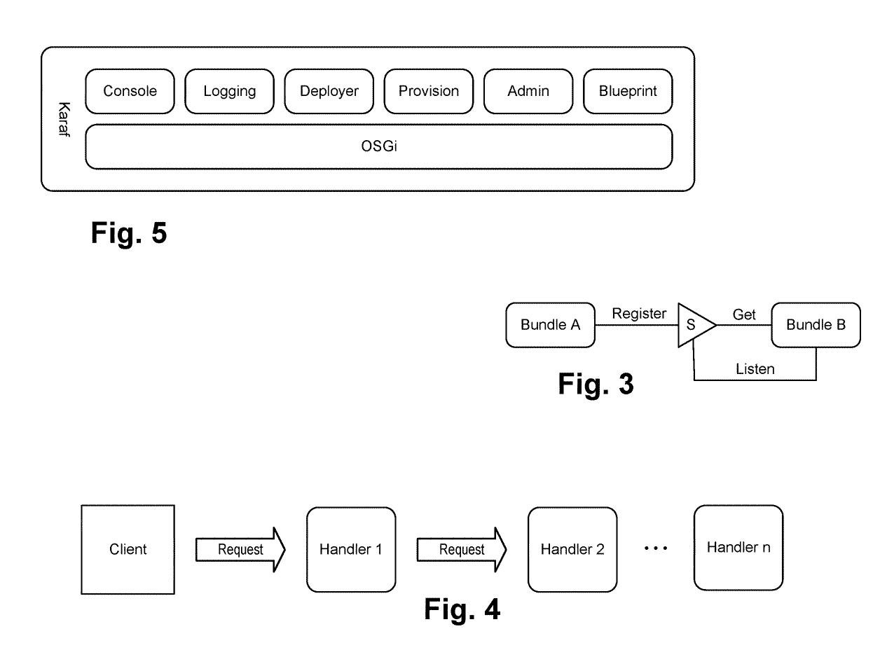

### DETAILED DESCRIPTION

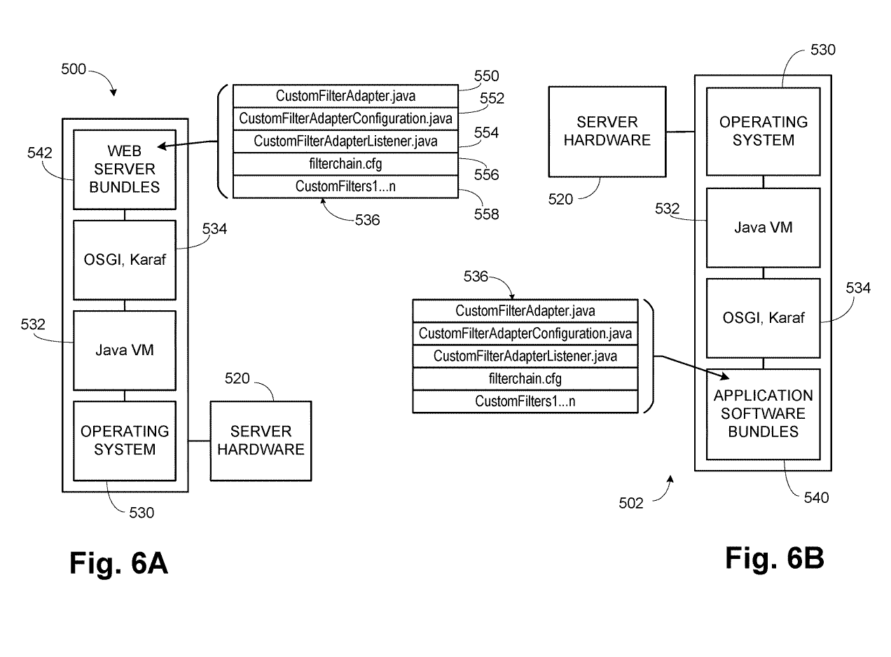

Referring now to FIGS. 6A-B, an exemplary web server 500 and an exemplary application server 502, such as an OpenDaylight® software defined network (SDN) controller, are illustrated. Each server 500, 502 is configured on system hardware 520 and includes an underlying operating system 530, Java VM 532 and OSGi environment and Apache Karaf 534 as discussed above. Network connections are not shown for simplicity. The application server 502 includes application software bundles 540 to provide the software for the desired application, such as OpenDaylight. The web server 500 includes web server bundles 542 to provide the desired web server functionality. Both the application software bundles 540 and the web server bundles 542 include custom filter software and files 536 according to the present invention. The custom filter software and files 536 are described in more detail below. These are very simple block diagrams and many variations and configurations can be developed, as known to one skilled in the art. It is also understood that each server 500, 502 includes a processor for executing software programs and RAM and non-volatile storage to provide operating memory and software storage, respectively. If is further understood that each server 500, 502 includes a network interface for receiving packets, such as HTTP requests, from a network-connected source.

The custom filter software and files 536 contain a number of different software modules and a file in the preferred embodiment. The software modules include CustomFilterAdapter.java 550, CustomFilterAdapterConfiguration.java 552, CustomFilterAdapterListener.java 554 and various CustomFilters 558. A filterchain.cfg file 556 is also present. Source code for CustomFilterAdapter.java 550, CustomFilterAdapterConfiguration.java 552, CustomFilterAdapterListener.java 554 are provided in the source code appendix incorporated above.

At a high level, CustomFilterAdapter.java 550 provides the mechanism to execute the desired custom filters, CustomFilterAdapterConfiguration.java 552 provides the desired custom filter CoR to CustomFilterAdapter.java 550 and initializes the custom filters, CustomFilterAdapterListener.java 554 detects changes in the filterchain.cfg file 556 to allow CustomFilterAdapterConfiguration.java 552 to determine the changes in the desired custom filters and filterchain.cfg file 556 contains a CSV (comma separated value) list of the desired custom filters in CoR order and with options indicated. Desired filter changes can also be provided directly to CustomFilterAdapterConfiguration.java 552 using an Apache Karaf console.

CustomFilterAdapter.java 550 is a customized implementation of the JDK (Java Development Kit) provided javax.servlet.Filter, and is used as the entry point. CustomFilterAdapter.java 550 is added to an HTTP/S Servlet in the relevant bundles 540, 542. CustomFilterAdapter.java 550 thus intercepts all HTTP/S requests and responses. CustomFilterAdapter.java 550 recreates a, or creates its own, Chain of Responsibility pattern for javax.servlet.Filter through CustomFilterChain. The CustomFilterAdapter.java 550 owns an optionally empty chained collection of CustomFilters 558. This is most easily understood by correlating filters as links in a chain. The chain is dynamically configurable through the Apache Karaf Configuration Admin service at runtime. Filters may be added, removed, and reconfigured dynamically without recompiling or restarting the HTTP/S Servlet. In other words, the chain may be lengthened or shortened with different types of links, and the individual links may be reconfigured at runtime, as explained more below. Links from different bundles (vendors) are permitted through using OSGi's Dynamic-ImportPackage functionality, so newly developed and purchased Filters can be added without stopping the server. This allows the system and its operators to configure filtering on the fly, enabling live debugging, security analytics, and on-demand service configuration. Service configuration includes (but is not limited to) whitelisting, blacklisting, rate limiting, analytics generation, load balancing and other common techniques often owned by external software or hardware entities.

Network and website administrators and operators may not be the only actor who has permission to configure the CustomFilterAdapter. In some embodiments autonomous services owned by the implementing system may dynamically configure Filters based off performance metrics, security threat level, desired accounting verbosity, or other measures of health of the server.

The Filters may be used to glean certain information from incoming HTTP/S requests prior to forwarding the request to the servlet. The gleaned information may be sent to an external source for offline processing. The server might also forward the request inline to external entity (i.e., firewall) to do enhanced filtering externally on the request.

This does not need to apply to just HTTP/S. This same pattern may apply to SDN controller southbound protocols as well, such as OVSDB (Open vSwitch Database Management Protocol), NETCONF (Network Configuration Protocol), and OpenFlow®.

Some examples are provided here.

Debugging: A filter is chained to provide enhanced information on the incoming request headers, payload, IP address, or other HTTP attributes.

Timing statistics for how long the request took to process by the server (i.e., how long RESTCONF takes to process request through MD-SAL), in order to optimize internal services based on minimizing process time.

Security: Whitelisting, blacklisting, rate limiting, forwarding requests to an external entity for processing, security auditing, accounting, active/passive IdP, etc.

Server health: rate limit to stop someone from killing the server with (D)DOS.

Pre-processing and post-processing Translation Services: Modify incoming requests or responses in order to better interact with established protocols. For example, modifying payloads to comply with established YANG schemas, modifying replies to provide enhanced information to client consumers, etc.

Dynamic Professional Services: Allow the system or operators to decide what to turn on and when in order to gather information. During low loads, perhaps this means logging with great verbosity. During high loads, this may mean limiting logging verbosity. If security threats are determined externally, enhanced security features may be enabled. If new Filters are discovered from external vendors (i.e., some other project provides a cool filter), it can be added at runtime without stopping the server and interrupting provided service.

Health over time: Stats generated from filtered information may be processed and plotted over time to determine if server capacity is adequate for server load. This also allows for operators to determine the performance effects of injecting a new filter by comparing against a baseline.

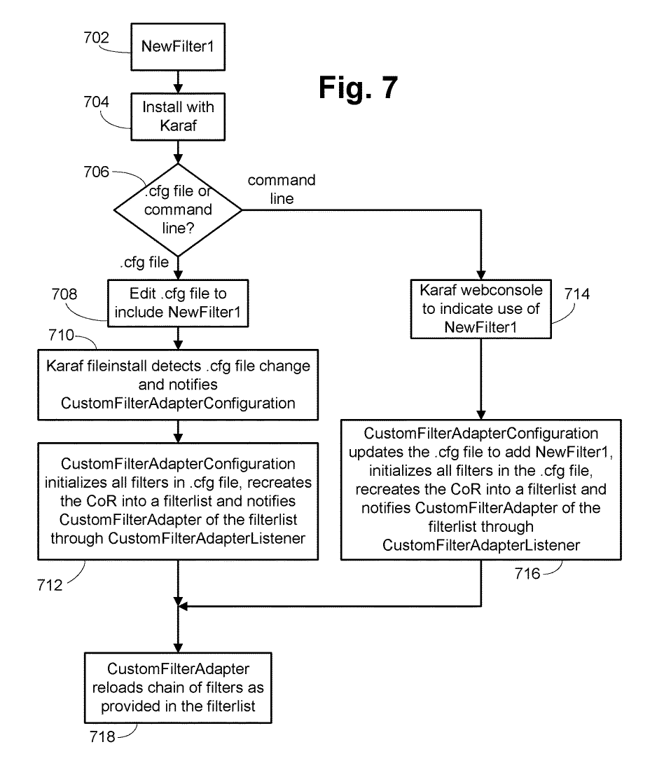

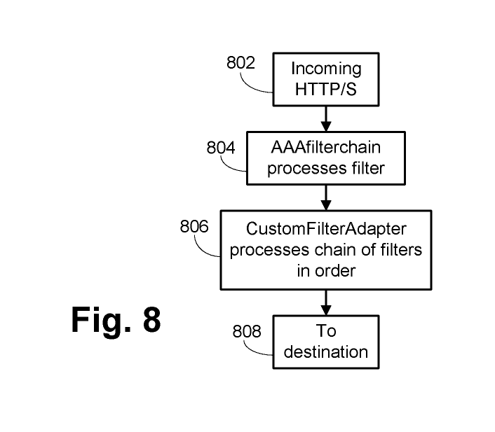

FIGS. 7 and 8 illustrate operation of the preferred embodiment. In step 702 a new custom filer NewFilter 1 is obtained, either by development or downloading from a source. In step 704 NewFilter 1 is installed as a bundle using Apache Karaf. In step 706, a choice is made on using the .cfg file method or the Karaf console method. If using the .cfg file method, in step 708 the filterchain.cfg file is edited using any suitable text file editor. An example filterchain.cfg file is provided here in Table 1 for reference.

TABLE 1
Example filterchain.cfg file

customFilterList=com.brocade.bvc.filters.SSLHostnameIPMismatchFilter,com.brocade.bvc.filters
.RequestResponseLoggingFilter
com.brocade.bvc.filters.RequestResponseLoggingFilter.maxOutputLength=4000
com.brocade.bvc.filters.SSLHostnameIPMismatchFilter.hostname=test

In the example, two filters, SSLHostnameIPMismatchFilter and RequestResponseLoggingFilter, are indicated, with the values separated by a comma. Parameters for each filter are provided in the lines following the filter list.

In step 710 Karaf fileinstall, part of the Karaf suite, detects the editing of the filterchain.cfg file and notifies CustomFilterAdapterConfiguration.java 552. In step 712 CustomFilterAdapterConfiguration.java 552 initializes all filters in filterchain.cfg, recreates the CoR into a filterlist and notifies CustomFilterAdapter.java 550 of the updated CoR via CustomFilterAdapterListener.java 554. Alternatively, CustomFilterAdapterConfiguration.java 552 can initialize just NewFilter 1. In step 718 CustomFilterAdapter.java 550 reloads the filters according to the CoR as indicated in the provided filterlist.

If the command line option was selected in step 706, in step 714 the operator uses a Karaf console, such as the webconsole, to indicate the use of NewFilter 1 to CustomFilterAdapterConfiguration.java 552. In step 716 CustomFilterAdapterConfiguration.java 552 updates the filterchain.cfg file to include NewFilter 1 as indicated, initializes all filters in filterchain.cfg, recreates the CoR into the filterlist and notifies CustomFilterAdapter.java 550 of the new filterlist through CustomFilterAdapterListener.java 554. In step 718 CustomFilterAdapter.java 550 operates as above.

Removal of a filter is similar except that instead of adding a filter to the CoR, a filter is removed from the CoR. Reconfiguration of a given filter is also similar, except only the parameters for the filter are changed.

In step 802 an HTTP/S request is received. In step 804 AAAfilterchain, the default filter chain, processes the HTTP/S request using its filter. In step 806 CustomFilterAdapter.java 550 receives the HTTP/S request from AAAfilterchain and processes the request through each of the filters indicated in CustomFilterChain value in the CoR as established in the CustomFilterChain value, basically in the order listed. In an alternative embodiment, AAAfilterchain can be included in the CoR executed by CustomFilterAdapter.java 550 as a first filter, thus removing step 804. In step 808 CustomFilterAdapter.java 550 provides the filtered HTTP/S request to the destination servlet.

For further details, reference to the incorporated source code listing is recommended.

Therefore, by maintaining a CoR of filters as a value that is updated dynamically, filters can be added or removed without restarting the system or recompiling the system. This greatly improves overall flexibility and uptime of the system and eliminates service interruptions.

The above description is intended to be illustrative, and not restrictive. For example, the above-described embodiments may be used in combination with each other. Many other embodiments will be apparent to those of skill in the art upon reviewing the above description. The scope of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method comprising:
executing a Java virtual machine (JVM);
executing an Open Service Gateway Initiative (OSGi) environment in the JVM;
executing a Java-based application in the OSGi environment, the Java-based application receiving Hypertext Transfer Protocol (HTTP) requests;
providing and executing a filter servlet in conjunction with the Java-based application, the filter servlet receiving the HTTP requests prior to the Java-based application and executing to perform filter operations on the HTTP request based on a chain of responsibility; and
providing and executing at least one filter for execution by the filter servlet, the at least one filter executing when the filter servlet is performing a filter operation,
wherein at least one filter is dynamically inserted into the chain of responsibility of the filter servlet.

2. The method of claim 1, further comprising:
providing a configuration file containing an indication of at least one filter to be executed by the filter servlet, the filter indications contained in the configuration file being in chain of responsibility order.

3. The method of claim 2, further comprising:
providing and executing a configuration program which executes to review the configuration file and develop and provide the chain of responsibility to the filter servlet.

4. The method of claim 3, further comprising:
executing a container handling hot deployment of programs in the OSGi environment and providing a console interface, the container coupled to the configuration program to allow editing of the chain of responsibility using the console interface to add a filter to the chain of responsibility.

5. The method of claim 4, wherein the container is Apache Karaf.

6. The method of claim 3, further comprising:
providing and executing a listening program which executes to determine that the configuration file has been edited and provides an indication of such editing to the configuration program.

7. The method of claim 1, wherein at least one filter is dynamically removed from the chain of responsibility of the filter servlet.

8. The method of claim 1, wherein the at least one filter has parameters and wherein the parameters can be dynamically changed.

9. A non-transitory computer readable medium or media having computer-executable instructions stored thereon for operating a computer system to perform a method comprising:
executing a filter servlet in conjunction with a Java-based application, the filter servlet receiving Hypertext Transfer Protocol (HTTP) requests prior to being provided to the Java-based application and performing filter operations on the HTTP request based on a chain of responsibility; and
executing at least one filter for execution by the filter servlet when the filter servlet is performing a filter operation,
wherein at least one filter is dynamically inserted into the chain of responsibility of the filter servlet.

10. The non-transitory computer readable medium or media of claim 9, the method further comprising:
providing a configuration file containing an indication of at least one filter to be executed by the filter servlet, the filter indications contained in the configuration file being in chain of responsibility order.

11. The non-transitory computer readable medium or media of claim 10, the method further comprising:
executing a configuration program which reviews the configuration file and develops and provides the chain of responsibility to the filter servlet.

12. The non-transitory computer readable medium or media of claim 11, the method further comprising:
executing a container handling hot deployment of programs in an Open Service Gateway Initiative (OSGi) environment to provide a console interface, the container coupled to the configuration program to allow editing of the chain of responsibility using the console interface to add a filter to the chain of responsibility.

13. The non-transitory computer readable medium or media of claim 11, the method further comprising:
executing a listening program which determines that the configuration file has been edited and provides an indication of such editing to the configuration program.

14. The non-transitory computer readable medium or media of claim 9, wherein at least one filter is dynamically removed from the chain of responsibility of the filter servlet.

15. A computer system comprising:
a processor;
a network interface coupled to the processor; and
a non-transitory computer readable medium storing computer-executable instructions for operating a computer system to perform a method including:
executing a filter servlet in conjunction with a Java-based application, the filter servlet receiving Hypertext Transfer Protocol (HTTP) requests prior to being provided to a Java-based application and performing filter operations on the HTTP request based on a chain of responsibility; and
executing at least one filter for execution by the filter servlet when the filter servlet is performing a filter operation,
wherein at least one filter is dynamically inserted into the chain of responsibility of the filter servlet.

16. The computer system of claim 15, the method further comprising:
providing a configuration file containing an indication of at least one filter to be executed by the filter servlet, the filter indications contained in the configuration file being in chain of responsibility order.

17. The computer system of claim 16, the method further comprising:
executing a configuration program which reviews the configuration file and develops and provides the chain of responsibility to the filter servlet.

18. The computer system of claim 17, the method further comprising:
executing a container handling hot deployment of programs in an Open Service Gateway Initiative (OSGi) environment to provide a console interface, the container coupled to the configuration program to allow editing of the chain of responsibility using the console interface to add a filter to the chain of responsibility.

19. The computer system of claim 17, the method further comprising:
executing a listening program which determines that the configuration file has been edited and provides an indication of such editing to the configuration program.

20. The computer system of claim 15, wherein at least one filter is dynamically removed from the chain of responsibility of the filter servlet.
